(19) United States
(12) Patent Application Publication
(10) Pub. No.: US 2008/0269538 A1
(43) Pub. Date: Oct. 30, 2008

(54) Waste Treatment Process

(75) Inventor: Guy Depelsenaire, Court-Saint-Etienne (BE)

Correspondence Address: Solvay North America, LLC;c/o Kim Manson, Esq., 4500 McGinnis Ferry Road, Alpharetta, GA, 30005, US

(73) Assignee: Solvay S.A., Brussels (BE)

(21) Appl. No.: 12/160,279

(22) PCT Filed: Jan. 11, 2007
(86) PCT No.: PCT/EP2007/050257

§ 371 Date: Jul. 8, 2008

(30) Foreign Application Priority Data
Jan. 13, 2006 (BE) 2006/0030

(51) Int. Cl. A62D 3/30

(52) U.S. Cl. 588/313

(57) ABSTRACT

Process for treating waste containing heavy metals, the process including a phosphating operation, a step of foaming the waste and a step of drying the foam, in which the waste undergoing the treatment results from the addition, to a base waste lightly contaminated with heavy metals, of a secondary waste whose content of heavy metals is at least twice that of the base waste.

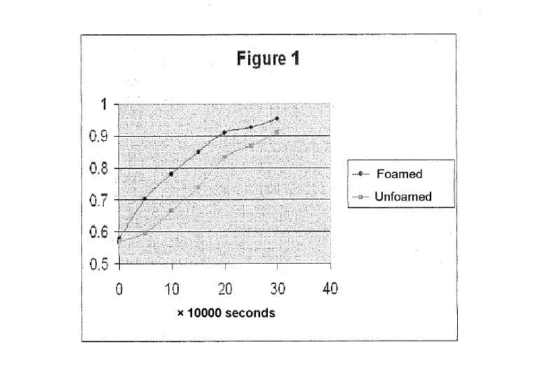

The invention relates to a process for treating waste, particularly waste contaminated by heavy metals and organic substances, for example those coming from sediments from the cleaning-up of navigable waterways or from polluted soils.

The problems posed by the ever increasing quantities of waste to be discharged, treated and stored are well known. This waste arises from many sources. For example, it comes from water purification stations, from the dredging or cleaning-up of water courses, or from various industries, and may contribute to soil contamination. The case of the sediments arising from the cleaning-up of navigable waterways is particularly of concern given the quantities involved and their contamination with pollutants, such as heavy metals and organic substances. A substantial proportion of the navigable waterways in northern Europe are presently obstructed by sludge that impedes the traffic of shipping. The economic and environmental consequences, whether direct or indirect, are very substantial. It is also manifest that this preoccupying situation as regards the navigable network is mainly due to the drawbacks of current solutions for the treatment and storage of contaminated waste.

A convenient means of discharging the waste consists in dumping it by boat into the sea or conveying it to discharge sites. However, when the waste is contaminated with heavy metals or hazardous organic substances (which is generally the case with sediments arising from the cleaning-up of navigable waterways), this means is obviously unacceptable. This is because, before the waste can be stored, it must be treated so as to pass the non-toxicity tests. It is also important to be able to dry it effectively and economically, so as to make it easier to handle and store it.

To treat large quantities of waste, it is known to mix it with phosphoric acid and subject the mixture to a foaming operation, so as to render the heavy metals inert (SOLVAY WO 2004/035490). However, the use of this known process has the drawback in certain cases of being relatively expensive, especially because of the quantity of additives that have to be added to the waste in order to obtain sufficient inerting, in particular when the heavy metal content of the waste is high.

The aim of the invention is to provide a waste treatment process which is more economic than the abovementioned known process and which rapidly converts the waste into inerted products of sufficient mechanical integrity to be easily handled, for example by worksite equipment (shovel loaders, bulldozers, etc.).

Consequently, the invention relates to a process for treating waste containing heavy metals, in which the heavy metals are inerted by phosphating them, characterized in that the waste subjected to the treatment results from the addition, to a base waste lightly contaminated with heavy metals, of a secondary waste, the content of at least one of the heavy metals As, Cd, Cr, Cu, Hg, Ni, Pb and Zn is at least five times that of the same metal in the base waste.

The process includes the phosphating of the waste. The phosphating is advantageously carried out by the addition of phosphoric acid. The amount of phosphoric acid to be used depends on the precise composition of the waste to be treated and especially on the content of heavy metals. In practice, a weight amount of at least 1% (preferably 2%) relative to the weight of dry matter should be employed. It is preferable that the amount of phosphoric acid be less than 15%. Amounts between 2 and 6% are in general very suitable.

It is advantageous to use highly diluted phosphoric acid in which an economic source of phosphate, such as certain phosphate ores containing P₂O₅ or residues from the calcination of animal flour, also rich in phosphates, is dissolved. For example, starting from an acid whose concentration corresponds to 20 ml of phosphoric acid diluted to 85% in 980 ml of water and the addition thereto of phosphate ores or calcined animal flour, an acid suitable for the process according to the invention is obtained very economically. It has been observed that the waste phosphating operation makes it possible to obtain a waste in which toxic compounds present in the waste are inerted and consequently, when the waste is stored, these toxic compounds do not contaminate the environment of the storage site.

According to the invention, the waste subjected to the treatment results from the addition, to a base waste lightly contaminated with heavy metals, of a secondary waste whose content by weight of at least one, advantageously two, preferably three, or more preferably four and particularly preferably five heavy metals As, Cd, Cr, Cu, Hg, Ni, Pb and Zn is at least twice, advantageously three times, preferably five times and more preferably ten times that of each of the corresponding heavy metals of the base waste.

The base waste and the secondary waste do not necessarily contain all the heavy metals mentioned. They may contain other ones, it is recommended that at least one or other waste contain arsenic, since the process according to the invention is particularly useful for inerting this toxic metal.

Particularly preferably, the total content of all the heavy metals of the secondary waste is at least twice, advantageously three times, preferably five times and more preferably ten times that of the base waste. The heavy metal content in question therefore results from the addition of all of the heavy metal contents of the wastes. The expression “all the heavy metals” is understood to mean metals having a density of at least 5 g/m³, and also beryllium, arsenic, selenium and antimony.

Advantageously, the secondary waste contains, as dry matter; at least 20 mg/kg of arsenic (As) and/or cadmium (Cd); and/or 200 mg/kg of chromium (Cr) and/or nickel (Ni); and/or 5000 mg/kg of copper (Cu) and/or lead (Pb) and/or zinc (Zn).

The contents are advantageously measured by ICP-OES (inductively coupled plasma-optical emission spectroscopy).

It is desirable for the secondary waste to be added in a quantity greater than 1%, advantageously 5%, preferably 10% and more preferably 15% by weight of dry matter of the base waste. It is recommended that this quantity does not exceed 50%, preferably 40% more preferably 30%.

The waste subjected to the treatment according to the invention may be of solid form or in the form of sludge.

The term “sludge” is understood to mean any aqueous substance containing solid matter in suspension. The sludge may be of natural origin or may result from the addition of water to a pulverulent solid substance, for example obtained by grinding. When the sludge is of natural origin, it advantageously contains mud, silt and mineral matter in suspension (sand, or even gravel). The sludges coming from the cleaning-up of navigable waterways or from polluted soils constitute examples of natural sludges to which the invention applies. Moreover, the sludges resulting from the addition of water to incineration waste or to automobile grinding residues are examples of artificial sludges to which the invention applies. The width of the particle size distribution of the particles suspended in the sludge may be very broad, for example from less than 1 micron to several hundred microns, or even several millimetres. The sludge often has a high content of very fine particles. It is frequently the case that 10% of the weight of dried sludge consists of particles having a diameter of less than 5 microns, whereas the content of particles having a diameter greater than 500 microns may amount to several percent. Moreover, the particle size histograms of certain sludges have the feature of being multimodal, that is to say they exhibit several peaks.

For the process according to the invention, waste having solids contents of less than 70% are very suitable, the solids content being defined as the percentage by weight of dry matter contained in the waste. In this description, the solids content of a specimen is determined by calculating the ratio of the weight of the specimen after being left for four hours in an oven maintained at 100° C. to the weight of said specimen before this operation. Solids contents of less than 30% or in certain cases 40% are preferably to be avoided. If the solids content is greater than 70%, it is necessary in certain cases to add water so that the phosphating operation can be carried out in an optimum manner.

In an advantageous variant of the process according to the invention, the base waste is formed from sludge and the secondary waste is in solid form. In this variant, the addition of the solid secondary waste allows the base waste solids content, when it is insufficient, to be increased in a simple and economic manner.

In a recommended variant of the process according to the invention, the waste undergoes a foaming operation, after which it is in the form of a foam (the term “foam” is understood to mean, for a given starting product, a state of this product having a lower density than the starting product). The foaming operation makes the subsequent handling of the waste easier. Specifically, the inventors have observed that, after a storage period typically varying from 2 to 7 days, preferably 4 to 6 days, during which the waste, initially in the foam state, is left to stand at usual outdoor temperatures (but preventing it from freezing), its consistency approaches that of a solid body that can be easily handled by worksite machines, such as shovel loaders or bulldozers, while still containing a lot of water (typically up to 40% by weight). Low-density foams appeared to provide the best consistencies. The density of the foam must be less than 95% of that of the waste before treatment. Values of less than 90%, preferably less than 85% and more preferably less than 80% are advantageous. Preferably, the density does not drop below 30%. Values between 60 and 75% are particularly suitable.

The waste may be foamed by any known foaming technique suitable for the waste to be treated. In general, the phosphating of the waste by means of phosphoric acid results in sufficient gas evolution to achieve the foaming. If the evolution is insufficient, the foaming may especially be obtained chemically, by the addition of reactants that cause in situ gas evolution. In a preferred method of implementing the reaction, an acid, such as hydrochloric, sulphuric or phosphoric acid, with for example a carbonate is used to achieve the gas evolution. It is observed that H₂S gas evolution during phosphating improves the foaming of the sludges. The addition or the presence of surfactants that stabilize the foam is also favourable. In this regard, it has been observed that certain humic acids in the sludge resulting from the cleaning-up of navigable waterways have a favourable effect on foaming, probably due to their surfactant character. Depending on the waste treated, it will however be possibly necessary to add certain surfactants in order to obtain a foam having a density according to the invention. The selection of the most appropriate surfactant and of the amount to be used will be made on a case-by-case basis, in a manner known per se. Moreover, it is preferable for the waste to undergo mechanical agitation in order to facilitate the foaming operation. The intensity of the agitation is chosen according to the particular operating conditions of the process according to the invention. It is advantageous that the mechanical agitation not be too intense. The use of mixing screws is in general to be avoided as these very often prevent the formation of foam. The use of tube reactors, which are segments of tubes that may or may not be provided with static mixers, is recommended. Advantageously, they are dimensioned so as to obtain a residence time therein of between 2 and 10 seconds. In each case, the mechanical agitation is controlled so as to promote the foaming according to the invention. In certain cases, it is preferable for the reactant causing the foaming to be added to the waste upstream of its passage through a pump, which will bring about the desired mechanical agitation. The use of static mixers may also be advantageous for obtaining the optimum mechanical agitation intensity.

The foaming step advantageously includes a maturation period. This is because the reaction of the waste with the phosphoric acid and/or any other reactant requires a certain amount of time. It is recommended that the duration of the maturation period be sufficient for 80%, preferably 90% and more preferably 95% of the reactants employed to have reacted. In general, a period of 2 days, preferably 3 days, is very suitable.

The process according to the invention makes it possible to treat waste having high heavy metal contents using few additives, in particular phosphoric acid. Specifically, it has been observed that a waste comprising up to 30% of secondary waste may, surprisingly, be treated using the same proportions of reactants as for the treatment of the base waste alone, in the absence of the secondary waste, whereas the treatment of the secondary waste alone requires at least double the quantities of reactants.

It has also been observed that the particles of the waste that have the largest diameters may uselessly absorb the reactants used for the foaming operation, such as acids and surfactants. This is particularly true when these particles are porous or consist of felts or foams, for example coming from the electrostatic agglomeration of organic fibres. This is particularly the case when the waste results from the addition of water to a residue that has been ground beforehand, since the fibres remain after grinding the residue and then agglomerate into coarse particles.

In a recommended method of implementing the process according to the invention, the coarsest particle size fraction of the waste is firstly separated. The determination of the particle size fraction to be separated depends on the nature of the waste. This is because it is preferable to separate the fraction that is most absorbent. In practice, it is often recommended to separate a particle size fraction corresponding to 5%, preferably 10% and even more preferably 20% by weight of the particles of the waste.

When the waste is in the form of natural sludge, the separation of the coarsest particle size fraction may be achieved for example by passing the sludge through filters or strainers. When the sludge is artificial sludge and results from the addition of water to pulverulent matter, it is preferable to carry out the separation before the water is added, for example by screening. The size of the apertures of the strainer or screen may be determined by trial and error, so as to obtain the desired weight percentage of the particle size fraction separated. Thanks to this prior separation, the economic efficiency of the process is improved. When the waste undergoing the treatment results from the addition of a secondary waste in the solid state to a liquid base waste, the particle size separation is preferably carried out on the wastes taken separately.

According to an advantageous variant of the invention, the process includes a foaming step, and the foam obtained, after having advantageously undergone maturation, is dried by techniques similar to composting. In the rest of the description, the term “dried sludge” is understood to mean the product obtained after the foam has been dried. This product is not necessarily in the foam state, since the foam has a tendency to density as it dries. Composting is a well-known technique for the treatment of fermentable waste (i.e. waste capable of undergoing fermentation), such as green waste. It essentially consists in storing the waste for a long period in contact with air, at external ambient temperature, in order to allow the organic matter contained in the waste to degrade and the liquid that it contains to be removed by percolation. According to this method of implementing the invention, the use of techniques similar to composting for drying the foamed sludge containing organic matter—even non-fermentable matter—and heavy metals makes it possible, surprisingly, to achieve high solids contents very economically. The energy consumption during possible subsequent calcination of the foam is consequently reduced. The drying of the foam by techniques similar to composting even makes it possible to eliminate the calcination step when the degradation of the organic matter achieved is sufficient.

In the rest of the description, the term “drying” will always be understood to mean drying by techniques similar to composting. During drying, the waste is stored for a sufficiently long time for the water to be able to drain away spontaneously, through the action of gravity. A drying period of longer than 24 hours is necessary. Preferably, the drying lasts at least 48 hours. Drying for more than one month appears to be unnecessary. In practice, drying times between one and two weeks are very suitable.

As explained above, when the waste is in the form of a foam, the drying is easier and more effective. This is because the improved consistency of the dried foam allows its bulk handling by standard worksite machines and especially allows the foam to be turned over during composting. This allows the desired solids contents to be achieved more rapidly.

In a recommend variant of this method of implementation, the drying is carried out under conditions such that, after 12 days of drying, the dried foam reaches a solids content exceeding 65%, preferably 70%.

The drying may be carried out directly on the ground. However in an advantageous method of implementing the process according to the invention, the foam is placed on a layer of sand.

In this method of implementation, the sand layer itself is preferably placed on a water-impermeable membrane so as to prevent the ground from being contaminated by the heavy metals and to allow the water coming from the phosphated sludge during composting to be recovered. The membranes made of plastic, for example polyethylene or PVC, are very suitable.

The drying may be carried out in the open air, outdoors, without guarding against the action of rain and the full variations in temperature, provided that the temperature remains above 0° C. However, it is preferable to use a confined drying system, such as a composting tunnel. Such composting tunnels are well known in the field of industrial treatment of fermentable organic waste. Advantageously, the composting tunnel is equipped with air circulation systems and systems for collecting and treating the gases emitted, such as hydrogen sulphide. The hydrogen sulphide is preferably recovered and for example treated on a biofilter or reinjected during a possible calcination. It is preferable for the composting tunnel to include a layer of sand placed on a water-impermeable membrane.

In one advantageous method of implementation of the invention, especially when the waste contains a large amount of organic substances or when these have not sufficiently decomposed during drying, the treated waste, preferably in the form of dried foam, is calcined. The organic substances may be in the liquid state or in the solid state. For example, they may comprise apolar hydrocarbons, aliphatic or aromatic (monocyclic or polycyclic) hydrocarbons and halogenated solvents. The purpose of the calcination is to destroy these organic substances. The calcination is generally carried out at a temperature above 450° C., so that the organic substances are sufficiently destroyed. An excessive temperature should be avoided, which would have the result of vaporizing some of the heavy metals. In practice, the calcination temperature is below 1000° C. Preferably the calcination temperature is above 500° C. but below 800° C. In order for the organic substances to be destroyed particularly well and to volatilize the heavy metals as little as possible, it is especially advantageous that the calcination temperature be between 550° C. and 750° C.

It has been observed that the calcination is advantageously carried out in a controlled atmosphere.

For this purpose, in one particular method of implementing the process according to the invention, this atmosphere is an oxidizing atmosphere. This variant facilitates the setting of the subsequent possible mortar, as described below. In this case, it is possible for example to use the ambient air. It is then necessary to ensure that there is sufficient air available in the furnace.

In another particular method of implementation, the atmosphere is a reducing atmosphere. This method of implementation is particularly advantageous in that it inhibits the formation of chromium (VI).

The calcination time depends on the composition of the waste to be treated and on the position of the material in the calcination furnace. It must also be long enough to destroy the organic matter and preferably to produce sufficient pyrophosphate.

In one particular method of implementing the process according to the invention, the product resulting from the calcination step is mixed with water, before undergoing a setting and hardening operation. In this method of implementation, a reducing additive is preferably incorporated into the mixing water. To give an example, this additive may be selected from iron, manganese, iron (II) compounds, manganese (II) compounds and salts for reducing alkaline metals. Sodium sulphite is preferred. Advantageously, the reducing agent is added in an amount by weight between 0.1 and 1% of the weight of dry matter contained in the sludge.

During the calcination step, certain sludges, in particular those rich in calcite, give rise to the formation of pozzolanic materials. In this case, it is unnecessary to add a hydraulic binder in order to cause setting and hardening.

When a hydraulic binder is necessary to ensure setting and hardening, its precise constitution is not very critical. Commonly, it consists of Portland cement. Pozzolanic materials such as ash from the combustion of carbon may also be suitable. It is also necessary to add, when mixing the hydraulic binder with the calcination product intended to form a mortar, a sufficient amount of mixing water to obtain a plastic paste. The amount of hydraulic binder to be used depends on various parameters, in particular on the hydraulic binder selected, on the composition of the sludge and on the desired properties of the final product of the treatment process according to the invention, especially its mechanical strength. In practice, it is often recommended to employ an amount of binder by weight of greater than 1% of the weight of the calcination ash. According to the invention, it is desirable that the weight of hydraulic binder be less than 50% and preferably not exceed 30%.

In an advantageous variant of the process according to the invention, an amount by weight of hydraulic binder greater than 2% and less than 20% of the calcination product is used.

The form of the solid mass obtained after hardening, which may last several days, is that in which the mortar has been fashioned. It may for example comprise spherical or prismatic blocks or briquettes. It is compounded, substantially free of gaseous inclusions and consequently has good mechanical properties, especially sufficient hardness and sufficient impact strength to allow it to be handled and stored without any difficulty.

The compact solid mass obtained after the hardening meets the toxicity standards on extracted leachates using stringent procedures, such as those defined by the TL or NEN standards.

The French triple leaching or TL test is described in French standard XPX 31-210. The protocol of the test consists in grinding the material so as to be able to pass it through a 4 mm screen. This ground material is subjected to triple leaching with demineralized water, in a liquid/solid ratio equal to 10, with constant stirring. After each leaching, the content of heavy metals of the liquid is measured.

The Dutch test NEN consists in finely grinding the specimen (below 4 mm) and adding water to it in a water/solid ratio of 10. It is then kept for three hours at pH 7, then also three hours at pH 4 (which is the minimum pH of rainwater). The pH is adjusted continuously using a IN solution of nitric acid (a non-complexing acid). The heavy metal content of the liquid phase is then determined by analysis.

According to the United States test TCLP (toxicity characteristic leaching procedure), 100 g of solid matter are taken and passed through a 9.5 mm screen and the specimen is brought into contact for 18 hours with 2000 ml of a 5.7 g/l CH₃COOH solution.

The process according to the invention may for example apply:
to waste resulting from the settling of wastewater of industrial or municipal wastewater;
to waste resulting from the decontamination of soils, such as those of certain industrial sites;
to automobile grinding residues or to incineration ash;
to sediments resulting from the dredging or cleaning-up of rivers, lakes, wells or drains; and
to the sediments resulting from the cleaning-up of navigable waterways (e.g. ports, lakes, rivers, canals).

In one advantageous method of implementing the process according to the invention, the secondary waste comprises automobile grinding residues or incinerator fly ash. The term “fly ash” is understood to mean combustion ash that has been entrained by the combustion flue gases. This waste, rich in heavy metals, is very effectively treated by the process according to the invention.

In a preferred variant of this method of implementation, the waste comprises automobile grinding residues. In this variant, it is recommended to separate, from the waste, the particles retained on the 4 mm screen, preferably the 3 mm screen and even more preferably the 2 mm screen.

Next, water and phosphoric acid are added to the remaining waste, which is then foamed and dried. The separated particles are then preferably mixed with the dried sludge, for possible calcination. In this variant, the foam is particularly easy to obtain even without surfactant additives.

The examples described below bring out the benefit of the invention.

### EXAMPLE 1

### Not According to the Invention

In Example 1 waste resulting from automobile grinding residues having the following composition is treated:

TABLE 1

| | Weight content | |
|---|---|---|
| Constituents | (weight of dry matter) | |
| Cd | 21 | mg/kg |
| As | 41 | mg/kg |
| Cr | 530 | mg/kg |
| Cu | 14000 | mg/kg |
| Pb | 13000 | mg/kg |
| Zn | 14000 | mg/kg |
| Hg | 3 | mg/kg |
| Ni | 410 | mg/kg |

These contents were measured in the following manner:

added to the specimen (200 mg) were 1 ml of ultrapure 65% nitric acid and 3 ml of 37% ultrapure hydrochloric acid, the mixture then being subjected to microwave radiation in a hermetically sealed container, so as to mineralize it (i.e. to destroy the (hydro)carbon matrix in order to obtain a mineral residue containing the analytes).
This solution, to which an internal standard (scandium) was added, was made up to a volume of 50 ml with ultrapure water.

The solution to be analyzed was then filtered if necessary (0.45) and injected in the form of an aerosol into an argon plasma sustained by inductive coupling. At temperatures of 6000 to 8000 K, the atoms and ions formed from the specimen were excited and returned to the ground state emitting radiation with wavelengths characteristic of the element in the UV/visible range (130 nm to 800 nm) (ICP-OES).

The various radiation wavelengths were separated by diffraction on a grating having a large number of lines and the intensity of the selected lines was measured.

The concentration of element in the measurement solution was obtained after calibrating the instrument with solutions of known concentrations of each of the elements sought. The concentration of these elements in the starting specimen was then calculated taking into account the dilution performed during the various preparation steps.

Added to the waste (which had a bulk density of 0.98 kg/dm³) was 50% of water. The resulting mixture, having a density of 1.1 kg/dm³, to which 3.5% (by weight of dry matter) of 75% phosphoric acid was added, was introduced into a tube reactor, after which the mixture was in the form of a foam having a density of 0.74 kg/dm³. The waste was then calcined for two hours at 650° C.

After the calcination, the specimens were subjected to the NEN leaching test defined above, in water, with a liquid/solid ratio of 10. The results (in mg/kg) of the test are given in Table 2:

TABLE 2

| As | Cd | Cr | Cu | Hg | Ni | Pb | Zn |
|---|---|---|---|---|---|---|---|
| 0.05 | 0.11 | 22 | 0.22 | 0.0014 | 0.05 | 87 | 28 |

### EXAMPLE 2

### Not According to the Invention

In Example 2, specimens of a sludge taken from a canal were treated as base waste.

The weight composition of the sludge in terms of its main pollutants is given in Table 3 below:

TABLE 3

| | Weight content | |
|---|---|---|
| Constituents | (weight of dry matter) | |
| As | 11 | mg/kg |
| Cd | 6 | mg/kg |
| Cr | 270 | mg/kg |
| Cu | 170 | mg/kg |
| Ni | 320 | mg/kg |
| Pb | 310 | mg/kg |
| Zn | 6400 | mg/kg |
| Hg | 3 | mg/kg |

The sludge had a density of 1.2 kg/dm³. Added to the sludge was 3.0% (by weight of dry matter) of phosphoric acid. The phosphated waste, which had a density of 0.75, was then calcined for 2 hours at 650° C.

After the calcination, the specimens were subjected to the NEN leaching test defined above, in a liquid/solid ratio of 10. The results (in mg/kg) of the test are given in Table 4:

TABLE 4

| As | Cd | Cr | Cu | Hg | Ni | Pb | Zn |
|---|---|---|---|---|---|---|---|
| 0.05 | 0.004 | 29 | 0.05 | 0.0005 | 0.05 | 0.05 | 0.1 |

### EXAMPLE 3

### According to the Invention

The procedure was as in Example 2 except that 17.5% by weight of dry matter of the water-diluted waste treated in Example 1 was added to the sludge before being phosphated.

The NEN leaching test gave the following results:

TABLE 5

| As | Cd | Cr | Cu | Hg | Ni | Pb | Zn |
|---|---|---|---|---|---|---|---|
| 0.05 | 0.004 | 25 | 0.05 | 0.0005 | 0.05 | 0.05 | 0.4 |

Comparing Examples 1 and 3 shows that the addition of only 3.5% phosphoric acid to a waste mixture according to the invention makes it possible to achieve greater cadmium, copper, mercury, lead and zinc inerting than that obtained with the initial secondary waste taken in isolation. Moreover, comparing Examples 2 and 3 shows that the addition to the base waste lightly contaminated with heavy metals of large quantities by weight of a secondary waste highly contaminated with heavy metals has little or no effect, or even improves the inerting of the lightly contaminated waste.

### EXAMPLE 4

### Not According to the Invention

In Example 4, specimens of fly ash resulting from the filtration of the flue gases from a household waste incinerator were treated as base waste.

The composition by weight of the fly ash in terms of its main pollutants is given in Table 6 below:

TABLE 6

| | Weight content | |
|---|---|---|
| Constituents | (weight of dry matter) | |
| As | 43 | mg/kg |
| Cd | 190 | mg/kg |
| Cr | 315 | mg/kg |
| Cu | 760 | mg/kg |
| Hg | 3 | |
| Ni | 61 | mg/kg |
| Pb | 3900 | mg/kg |
| Zn | 9200 | mg/kg |

The fly ash had a bulk density of 0.56 kg/dm³. 50% of water was added thereto, in order to form a sludge having a bulk density of 1.43 kg/dm³. 3.5% of phosphoric acid (by weight of dry matter) was added to the sludge. The phosphated waste, which had a bulk density of approximately 1.27 kg/dm³, was then calcined for 2 hours at 650° C.

After the calcination, the specimens were subjected to the NEN leaching test defined above, in a liquid/solid ratio of 10. The results (in mg/kg) of the test are given in Table 7:

TABLE 7

| As | Cd | Cr | Cu | Hg | Ni | Pb | Zn |
|---|---|---|---|---|---|---|---|
| 0.05 | 0.056 | 130 | 0.05 | 0.0052 | 0.05 | 0.17 | 1.6 |

### EXAMPLE 5

### According to the Invention

The procedure was as in Example 2 except that a quantity of 11.1% by weight of dry matter of the water-diluted waste treated in Example 4 was added to the sludge.

The NEN leaching test gave the following results:

TABLE 8

| As | Cd | Cr | Cu | Hg | Ni | Pb | Zn |
|---|---|---|---|---|---|---|---|
| 0.05 | 0.004 | 35 | 0.05 | 0.0005 | 0.05 | 0.05 | 0.1 |

Comparing Examples 4 and 5 shows addition of only 3.5% phosphoric acid to a waste mixture according to the invention makes it possible to achieve greater cadmium, chromium, mercury, lead and zinc melting than that obtained starting with the secondary waste taken in isolation. Moreover, comparing Examples 2 and 5 confirms that the addition of a large quantity of waste highly contaminated with heavy metals is not detrimental, for most of the metals analysed, to the inerting of the lightly contaminated waste.

1. A process for treating waste containing heavy metals, in which the heavy metals are inerted by phosphating, wherein the waste undergoing the treatment is a waste mixture resulting from the addition, to a base waste lightly contaminated with heavy metals, of a secondary waste whose content of at least one of the heavy metals selected from the group consisting of As, Cd, Cr, Cu, Hg, Ni, Pb and Zn is at least five times that of the same metal in the base waste.

2. The process according to claim 1, wherein the process comprises, in succession, a step of foaming the waste mixture, under controlled conditions for obtaining a foam having a density of less than 90% of that of the waste mixture, and a step of drying the foam.

3. The process according to claim 1, wherein the content of the secondary waste of at least two of the heavy metals selected from the group consisting of As, Cd, Cr, Cu, Hg, Ni, Pb and Zn is at least five times that of the same metals in the base waste.

4. The process according to claim 3, wherein the total content of the secondary waste of the heavy metals selected from the group consisting of As, Cd, Cr, Cu, Hg, Ni, Pb and Zn is at least five times that of the base waste.

5. The process according to claim 1, wherein the secondary waste is added in a quantity of between 5 and 30% by weight of dry matter of the base waste.

6. The process according to claim 1, wherein the base waste is a sludge.

7. The process according to claim 1, wherein the secondary waste comprises automobile grinding residues.

8. The process according to claim 1, wherein the secondary waste comprises incinerator fly ash.

9. The process according to claim 1, wherein the base waste or the secondary waste contains arsenic.
